(19) United States
(12) Patent Application Publication
(10) Pub. No.: US 2007/0029921 A1
(43) Pub. Date: Feb. 8, 2007

(54) Electron emission display device having low resistance spacer

(76) Inventors: Sung Hwan Jin, Suwon (KR); Jong Sick Choi, Suwon (KR); Cheol Hyeon Chang, Yangsan (KR); Chun Gyoo Lee, Yongin (KR); Hyeong Rae Seon, Pusan (KR); Jae Hun Lee, Yongin (KR); Dong Su Chang, Ulsan (KR); Gi Young Song, Yongin (KR); Hyoung Cheol Seo, Daejeon (KR)

Correspondence Address: CHRISTIE, PARKER & HALE, LLP, PO BOX 7068, PASADENA, CA, 91109-7068, US

(21) Appl. No.: 11/495,189

(22) Filed: Jul. 28, 2006

(30) Foreign Application Priority Data
Jul. 29, 2005 (KR) 10-2005-0069811

(51) Int. Cl. H01J 1/30; H01J 63/04

(52) U.S. Cl. 313/495; 313/309; 313/258

(57) ABSTRACT

An electron emission display device includes an electron emission substrate; an electron emission device disposed on a region of the electron emission substrate; an auxiliary electrode electrically connected to the electron emission substrate at a portion other than the region where the electron emission device is disposed; an image forming substrate; an image implementing part corresponding to the electron emission device disposed on the image forming substrate; and a spacer for supporting the auxiliary electrode and the image forming substrate to be spaced apart from each other, the spacer comprising a conductive material. The space may be coated with a conductive material or doubly coated with two conductive materials, the two conductive materials having different resistances from each other.

### CROSS-REFERENCE TO RELATED APPLICATIONS

This application claims priority to and the benefit of Korean Patent Application Nos. 10-2005-0069811, filed on Jul. 29, 2005, in the Korean Intellectual Property Office, the entire content of which is incorporated herein by reference.

### BACKGROUND

An electron emission display device includes a cathode substrate, an anode substrate, a line-shaped cathode electrode disposed on a surface of the cathode substrate, and a line-shaped anode electrode disposed on a surface of the anode substrate to cross the cathode electrode in perpendicular relationship. On the surface of the cathode electrode is an electron emitting part for emitting electrons when an electric field is generated. On the surface of the anode electrode is the luminescent layer for emitting light when the electrons are emitted from the electron emitting part. On the anode substrate between the anode electrodes, spacers are disposed. The spacers prevent the substrates from deformation or damage when sealing the cathode substrate and the anode substrate under high vacuum.

FIG. 1 is a sectional view illustrating a part of the conventional electron emission display device having a spacer.

As shown in FIG. 1, in the conventional electron emission display device, a line-shaped cathode electrode 22 is disposed on a surface of a cathode substrate 21 and a surface type electron emitting part 23 is disposed on the cathode electrode 22. On an anode electrode substrate 11 facing the cathode substrate 21, line-shaped anode electrodes 12 cross the cathode electrode 22 in perpendicular relationship and are so disposed. On the anode electrodes, luminescent layers 14, in which electrons emitted from the electron emitting part 23 collide against and emit light, are disposed. Between the anode electrodes 12, auxiliary spacers 34a serving as a light-shielding film are disposed. In regions where the anode substrate 11 adheres to the cathode substrate 21, a plurality of spacers 34 are arranged at predetermined intervals. The spacers 34 are adhered with one of the anode substrate 11 and the cathode substrate 21 by frits.

Thus, when the spacers 34 adhere to the anode substrate 11 or the cathode substrate 21 due to the frit, a distance between the anode substrate 11 and the cathode substrate 21 (which may be predetermined) is maintained by the spacers 34.

However, some of the emitted electrons collide against the spacers in the vicinity of the spacers, or ions generated by the emitted electrons are attached to the spacers and charge the spacers. Since the charged electrons do not smoothly discharge electricity because of high resistance of the spacers, orbits of the electrons emitted by the electron emission devices are changed due to charge of the spacers and the emitted electrons arrive at other places than the corresponding phosphors so that distorted images are generated in the vicinity of the spacers.

### SUMMARY OF THE INVENTION

An electron emission display device includes an electron emission substrate; an electron emission device disposed on a region of the electron emission substrate; an auxiliary electrode electrically connected to the electron emission substrate at a portion other than the region where the electron emission device is disposed; an image forming substrate; an image implementing part corresponding to the electron emission device disposed on the image forming substrate; and a spacer for supporting the auxiliary electrode and the image forming substrate to be spaced apart from each other, the spacer including a conductive material.

In one embodiment, the spacer is fixed to at least one of the electron emission substrate or the image forming substrate by an adhesive, and the adhesive includes conductive material. On at least one side of the spacer may be located a low resistance material having a resistance equal to or less than a resistance of the adhesive. In one embodiment, the spacer has a resistance ranging from 104 Ωcm to 1014 Ωcm.

The conductive material of the spacer may include one metal selected from the group consisting of Ni, Cr, Au, Ag, Mo, W, Pt, Ti, Al, Cu, and Pd, one alloy selected from the group consisting of Ni, Cr, Au, Mo, W, Pt, Ti, Al, Cu, and Pd, one metal oxide selected from the group consisting of In2O3-SnO2, and RuO2, or poly silicon.

In one embodiment, on least one side of the spacer is located a conductor layer having a higher conductivity than that of the spacer, and the electron emission device includes: a cathode electrode; an electron emitting part electrically connected to the cathode electrode; a first insulating layer formed on the cathode electrode; a gate electrode crossing the cathode electrode to emit electrons from the electron emitting part; a second insulating layer formed on the gate electrode; and the auxiliary electrode formed on the second insulating layer to collect the electrons emitted by the gate electrode.

In another embodiment, an external power source independently applies voltage ranging from −50V to +100V to the auxiliary electrode. The image implementing part may include: luminescent layers emitting light due to electrons emitted from the electron emission device; a light shielding film disposed between the luminescent layers; and an anode electrode electrically connected to the luminescent layers.

A voltage may be applied to the anode electrode and a negative voltage corresponding to voltage applied to the anode electrode may be applied to the auxiliary electrode.

Another embodiment of an electron emission display device includes: an electron emission substrate; an electron emission device disposed on a region of the electron emission substrate; an auxiliary electrode electrically connected to the electron emission substrate at a portion other than the region where the electron emission device is disposed; an image forming substrate; an image implementing part corresponding to the electron emission device disposed on the image forming substrate; and a spacer for supporting the auxiliary electrode and the image forming substrate to be spaced apart from each other, the spacer coated with a conductive material.

The conductive material coating the spacer may include one metal selected from the group consisting of Ni, Cr, Au, Ag, Mo, W, Pt, Ti, Al, Cu, and Pd, one alloy selected from the group consisting of Ni, Cr, Au, Mo, W, Pt, Ti, Al, Cu, and Pd, one metal oxide selected from the group consisting of RuO2, and In2O3-SnO2, or poly silicon, and the spacer may have a resistance ranging from 104 Ωcm to 1014 Ωcm.

Another embodiment of an electron emission display device includes: an electron emission substrate; an electron emission device disposed on a region of the electron emission substrate; an auxiliary electrode electrically connected to the electron emission substrate at a portion other than the region where the electron emission device is disposed; an image forming substrate; an image implementing part corresponding to the electron emission device disposed on the image forming substrate; and a spacer for supporting the auxiliary electrode and the image forming substrate to be spaced apart from each other, the spacer having a first coating of a first conductive material and a second coating of a second conductive material, the first conductive material having a different resistance than the second conductive material.

The first or second conductive material may include one metal selected from the group consisting of Ni, Cr, Au, Ag, Mo, W, Pt, Ti, Al, Cu, and Pd, one alloy selected from the group consisting of Ni, Cr, Au, Mo, W, Pt, Ti, Al, Cu, and Pd, one metal oxide selected from the group consisting of RuO2 and In2O3-SnO2, or poly silicon.

In one embodiment, the spacer has a resistance ranging from 104 Ωcm to 1014 Ωcm, and is formed of an insulating material selected from the group consisting of silicon glass, glass containing Na, solar-lime glass, alumina, and ceramic containing alumina. In another embodiment, a thermal expansion coefficient of the spacer is approximately equal to a thermal expansion coefficient of the electron emission substrate and a thermal expansion coefficient of the image forming substrate.

### BRIEF DESCRIPTION OF THE DRAWINGS

These and/or other aspects and features of various embodiments of the invention will become apparent and more readily appreciated from the following description of examples of embodiments, taken in conjunction with the accompanying drawings of which:

FIG. 1 is a sectional view illustrating a part of a conventional electron emission display device having a spacer;

FIG. 2 is an exploded perspective view schematically illustrating the structure of an electron emission display device according to an embodiment of the present invention;

FIG. 3 is a sectional view schematically illustrating the structure of the electron emission display device according to the embodiment shown in FIG. 2;

FIG. 4 is a view schematically illustrating the structure of the spacer in FIG. 3;

FIG. 5A is a schematic view illustrating applying anode voltage and auxiliary electrode voltage to the electron emission display device having a low resistance spacer according to an embodiment of the present invention;

FIG. 5B is a schematic view illustrating independently applying auxiliary electrode voltage to the electron emission display device having a low resistance spacer according to an embodiment of the present invention;

FIG. 6 is a schematic view illustrating electric field generated by applying the anode voltage and auxiliary electrode voltage to the electron emission display device having a low resistance spacer according to the embodiment of the present invention as shown in FIGS. 5A and 5B;

FIG. 7 is a schematic sectional view illustrating the structure of an electron emission display device according to another embodiment of the present invention;

FIG. 8 is a schematic view illustrating a low resistance spacer in FIG. 7;

FIG. 9 is a schematic sectional view illustrating the structure of an electron emission display device according to another embodiment of the present invention; and

FIG. 10 is a schematic view illustrating the structure of a low resistance spacer in FIG. 9.

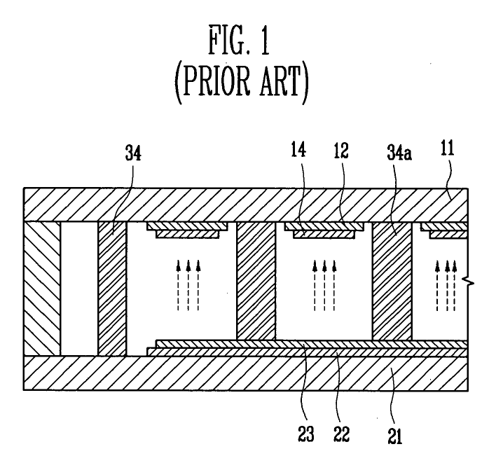

### DETAILED DESCRIPTION

Hereinafter, examples of embodiments according to the present invention will be described with reference to the accompanying drawings, wherein the described embodiments of the present invention are provided to be readily understood by those skilled in the art.

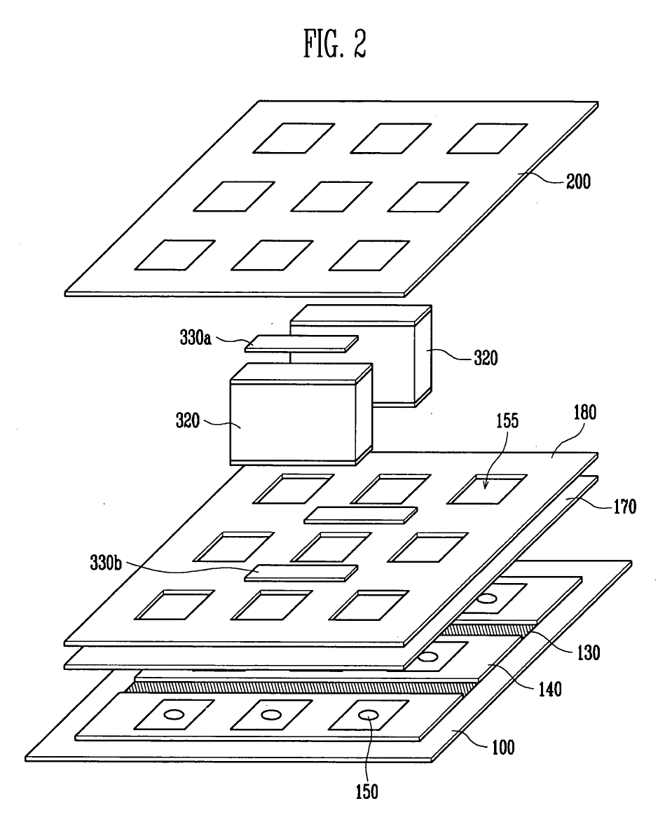

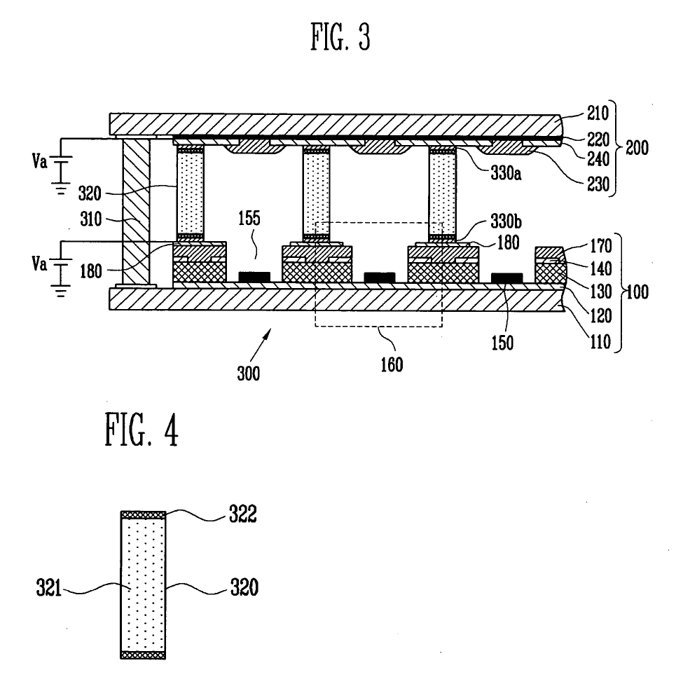

FIG. 2 is an exploded perspective view schematically illustrating the structure of an electron emission display device according to one embodiment of the present invention, and FIG. 3 is a sectional view schematically illustrating the structure of the electron emission display device according to the embodiment shown in FIG. 2.

As shown in FIGS. 2 and 3, the electron emission display device according to this embodiment of the present invention includes an electron emission substrate 100 in which at least one electron emission device 160 is disposed and an auxiliary electrode 180 is electrically connected to regions where the electron emission device 160 is not formed, an image forming substrate 200 having an image implementing part corresponding to the electron emission device 160, and spacers 320 positioned on the auxiliary electrode 180 of the electron emission substrate 100 to support the auxiliary electrode 180 to be spaced apart from the image forming substrate 200.

The electron emission substrate 100 includes an electron emitting region in which a plurality of electron emission devices 160 are arranged in regions where cathode electrode wires cross gate electrode wires in a predetermined form. In one embodiment, the wires cross in a matrix form. Each of the electron emission devices 160 includes a cathode electrode 120, a gate electrode 140 crossing the cathode electrode 120, a first insulating layer 130 for insulating positioned between the two electrodes 120 and 140, a second insulating layer 170 formed on the gate electrode 140, and an auxiliary electrode 180 formed on the second insulating layer 170. The electron emission substrate 100 also includes an electron emitting part 150 electrically connected to the cathode electrode 120. The electron emission device corresponds to phosphors 230 formed on the image forming substrate 200.

On a bottom substrate 110, at least one cathode electrode 120 is disposed in a predetermined shape, for example in a stripe shape. The bottom substrate 110 is generally glass or a silicon substrate. A transparent substrate, such as glass, is used in one embodiment for forming the electron emitting part 150 with carbon nanotube paste for bottom exposure.

The cathode electrode 120 supplies a data signal and a scanning signal respectively transmitted from a data driving part (not shown) and a scanning driving part (not shown) to respective electron emission devices. Here, each of the electron emission devices 160 includes the electron emitting part 150 formed in the region where the cathode electrode 120 crosses the gate electrode 140.

The first insulating layer 130 is formed on the cathode electrode 120 and electrically insulates the cathode electrode 120 from the gate electrode 140. The first insulating layer 130 is made of insulating material, such as a glass mixture of PbO and SiO₂.

The gate electrode 140 is formed on the first insulating layer 130 in a predetermined shape, for example, in a stripe shape, and is arranged to cross the cathode electrode 120. The gate electrode 140 supplies the data signal or the scanning signal respectively transmitted from the data driving part or the scanning driving part to the respective electron emission devices. The gate electrode 140 is made of metal with excellent conductivity such as gold (Au), silver (Ag), platinum (Pt), aluminum (Al), chrome (Cr), or at least one of alloys of gold (Au), silver (Ag), platinum (Pt), aluminum (Al), chrome (Cr).

The second insulating layer 170 is formed on the gate electrode 140, and electrically insulates the gate electrode 140 from the auxiliary electrode 180. The second insulating layer 170 is made of insulating material, such as a glass mixture of PbO and SiO₂.

The auxiliary electrode 180 is formed on the upper side of the second insulating layer 170 and is made of a metal with excellent conductivity such as gold (Au), silver (Ag), platinum (Pt), aluminum (Al), chrome (Cr), or at least one alloy of gold (Au), silver (Ag), platinum (Pt), aluminum (Al), chrome (Cr).

The auxiliary electrode 180 prevents the cathode electrode 120 and the gate electrode 140 from damage when arc discharging, and protects the cathode electrode 120, the gate electrode 140, and the electron emitting part 150 from the anode electric field generated due to high voltage applied to the anode electrode 220.

Openings 155 penetrate the first insulating layers 130, the gate electrodes 140, the second insulating layers 170, and the auxiliary electrodes 180, which are sequentially laminated. The openings 155 expose the cathode electrodes 120. The openings 155 are regions where the electron emitting parts 150 are formed. In other words, at least one opening 155 is formed in the regions where the cathode electrodes 120 cross the gate electrodes 140.

The electron emitting parts 150 are respectively electrically connected to the cathode electrodes exposed by the openings 155, and, in some embodiments, are made of carbon nanotube, graphite, graphite nanofiber, diamond-like carbon, C₆₀, silicon nanowire, or a combination thereof.

The image forming substrate 200 includes image forming regions having the anode electrode 220, the phosphors 230 formed on the anode electrode 220 to emit light due to electrons emitted by the electron emission devices 160, and light shielding films 240 formed between the phosphors 230.

The anode electrode 220 is positioned on a top substrate 210, and successfully collects the electrons emitted from the electron emission devices 160. For the collection of the emitted electrons, a positive (+) high voltage is applied to the anode electrode 220 such that the emitted electrons are accelerated toward the phosphors 230.

The top substrate 210 and the anode electrode 220, in one embodiment, are made of transparent material. For example, the top substrate is made of glass and the anode electrode 220 is made of ITO electrode so that light emitted from the phosphors 230 can be transmitted to the outside.

On the top substrate 210, the phosphors 230 for emitting light due to the collision of the electrons emitted from the electron emitting parts 150 are selectively arranged at predetermined intervals. As a G-phosphor, that is, a phosphor for emitting green light, ZnS:Cu, Zn₂SiO₄:Mn, ZnS:Cu+Zn₂SiO₄:Mn, Gd₂O₂S:Tb, Y₃Al₅O₁₂:Ce, ZnS:Cu,Al, Y₂O₂S:Tb, ZnO:Zn, ZnS:Cu,Al+In₂O₃, LaPO₄:Ce,Tb, BaO.6Al₂O₃:Mn, (Zn, Cd)S:Ag, (Zn, Cd)S:Cu,Al, ZnS:Cu,Au,Al, Y₃(Al, Ga)₂O₁₂:Tb, Y₂SiO₅:Tb, or LaOCl:Tb may be used. In this embodiment, ZnS:Cu,Al, is used. Moreover, as a B-phosphor, i.e., a phosphor for emitting blue light, ZnS:Ag, ZnS:Ag,Al, ZnS:Ag,Ga,Al, ZnS:Ag,Cu, Ga,Cl, ZnS:Ag+In₂O₃, Ca₂B₅O₉Cl:Eu²⁺, (Sr,Ca,Ba,Mg)₁₀(PO₄)₆Cl₂:Eu²⁺, Sr₁₀(PO₄)₆C₂:Eu²⁺, BaMgAl₁₆O₂₆:Eu²⁺, ZnS:Ag with addition of CoO,Al₂O₃, ZnS:Ag,Ga with addition of CoO,Al₂O₃, may be used, and in this embodiment, ZnS:Ag,Cl is used. As an R-phosphor, that is, a phosphor for emitting red light, Y₂O₂S:Eu, Zn₃(PO₄)₂:Mn, Y₂O₃:Eu, YVO₄:Eu, (Y, Gd)BO₃:Eu, γ-Zn₃(PO₄)₂:Mn, (ZnCd)S:Ag, (ZnCd)S:Ag+In₂O₃, or Fe₂O₃ added to Y₂O₂S:Eu may be used. In this embodiment, Y₂O₂S:Eu is used.

The phosphors 230 indicate independent monochrome phosphors. Although the phosphors 230 are disclosed as the phosphors for respectively emitting red-, green-, and blue-lights in this embodiment, the invention is not limited to these. The top substrate 210, in one embodiment, is made of transparent material to transmit light emitted from the phosphors 230 to the outside.

The light shielding films 240 absorb and intercept external light and are arranged between the phosphors 230 at predetermined intervals such that cross talk is prevented to improve contrast.

Metal reflecting films (not shown) may be further formed on the phosphors 230 for successfully collecting electrons emitted from the electron emitting parts 150 and reflecting light generated due to the collision of the electrons toward the top substrate 210 to improve the reflection efficiency.

Low resistance spacers 320 are positioned between the auxiliary electrodes 180 and the light shielding films 240, and are made of conductive material having insulation sufficient to endure a high voltage applied between the electron emission substrate 100 and the image forming substrate 200 and having conductivity sufficient to prevent charging the surfaces of the spacers 320.

The low resistance spacers 320 are made of material having sufficient insulation, such as silicon glass, glass containing Na, solar-lime glass, alumina, or ceramic containing alumina. In one embodiment, the thermal expansion coefficient of the low resistance spacers 320 approximates the thermal expansion coefficient of the electron emission substrate 100 and the image forming substrate 200.

Thus, the orbits of the electrons emitted from the electron emission substrate 100 are prevented from concentrating in the vicinity of the low resistance spacers 320 so that emission of different color light due to the orbit distortion of the electrons and the distortion and change of images due to the different color light emission can be reduced.

In one embodiment, the spacers 320 are attached to at least one of the electron emission substrate 100 and the image forming substrate 200 with conductive adhesives 330a and 330b, and, in this embodiment, are fixed by the adhesives 330a and 330b to the light shielding films 240 and the auxiliary electrodes 180.

The electron emission display device 300 as described above further includes a sealer 310 for sealing the electron emission substrate 100 and the image forming substrate 200 and for maintaining a vacuum.

FIG. 4 is a view schematically illustrating the structure of the spacer in FIG. 3. As shown in the drawing, the low resistance spacers 320 are formed by adding conductive material having insulation sufficient to endure a high voltage applied between the electron emission substrate 100 and the image forming substrate 200 and conductivity sufficient to prevent charging the surfaces of the spacers 320.

In more detail, the low resistance spacers 320 are made of material having sufficient insulation, such as silicon glass, glass containing Na, solar-lime glass, alumina, or ceramic containing alumina. In this embodiment, the thermal expansion coefficient of the low resistance spacers 320 approximates the thermal expansion coefficient of the electron emission substrate 100 and the image forming substrate 200.

The low resistance spacers 320 include low resistance material 321 such that the surface charging of the spacers 320 is prevented and distortion of electron emission paths due to the spacers 320 or the surface charging thereof are prevented. The low resistance material 321 for implementing the low resistance of the low resistance spacers 320 is selected from material with a sufficiently low resistance, for example, metals such as Ni, Cr, Au, Mo, W, Pt, Ti, Al, Cu, and Pd, alloys of Ni, Cr, Au, Mo, W, Pt, Ti, Al, Cu, and Pd, metals such as Pd, Ag, Au, and RuO₂, metal oxide of Pd, Ag, Au, and RuO₂, transparent conductors such as In₂O₃—SnO₂, and semiconductors, such as poly silicon.

By doing so, the low resistance spacers 320 can have resistance ranging from 10⁴ Ωcm to 10¹⁴ Ωcm.

On the sides of the low resistance spacers 320, low resistance materials 322 may be formed, and their resistance is equal to or less than the resistance of the adhesives 330a and 330b. On at least one of the sides of the low resistance spacers 320, a conductor layer having a higher conductivity than that of the low resistance spacers 320 may be formed.

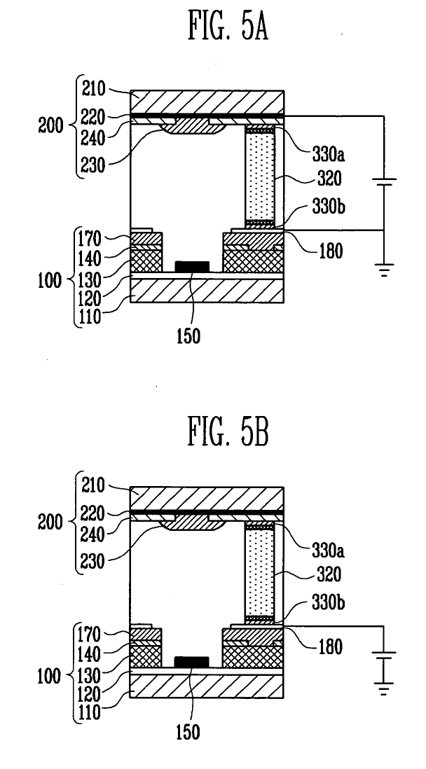

FIG. 5A is a view illustrating application of an anode voltage and an auxiliary electrode voltage to the electron emission display device having a low resistance spacer according to one embodiment of the present invention. As shown in the drawing, in the electron emission display device 300 having the low resistance spacers 320, an external power source applies a positive (+) voltage to the cathode electrode 120, a negative (−) voltage to the gate electrode 140, and a positive (+) voltage to the anode electrode 220. By doing so, due to the voltage difference between the cathode electrode 120 and the gate electrode 140, the electric field is generated around the electron emitting parts 150 and the electrons are emitted therefrom, the emitted electrons are guided by high voltage applied to the anode electrode 220 to collide against the corresponding phosphors 230 such that the phosphors 230 emit light to form predetermined images.

At that time, the auxiliary electrodes 180 apply the negative (−) voltage to the anode electrode 220 when applying the positive (+) voltage to the anode electrode 220, so that the electrons emitted from the electron emitting parts 150 are concentrated at the anode electrode 220.

FIG. 5B is a view illustrating independently applying auxiliary electrode voltage to the electron emission display device having a low resistance spacer according to one embodiment of the present invention. As shown in the drawing, a negative (−) voltage is independently applied to the auxiliary electrodes 180, so that electrons emitted from the electron emitting parts 150 are concentrated at the anode electrode 220. At that time, voltage ranging from −50V to +100V is independently applied to the auxiliary electrodes 220.

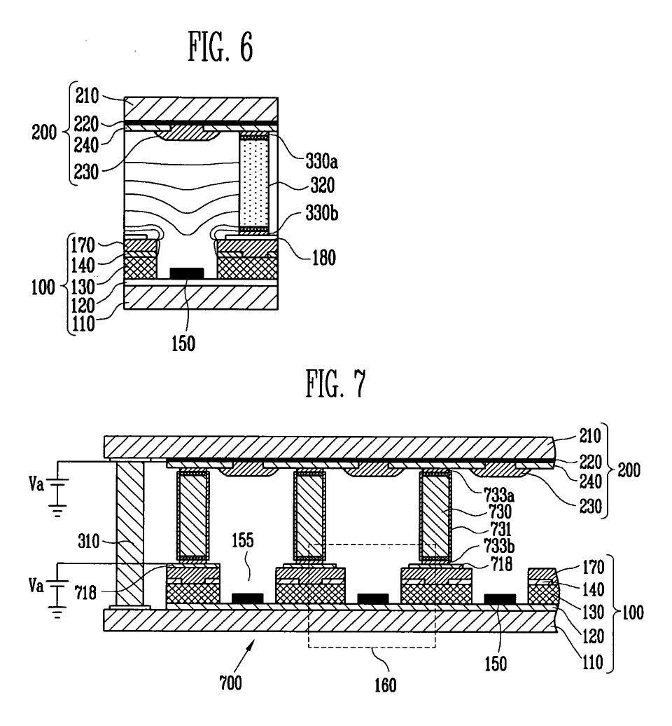

FIG. 6 is a schematic view illustrating an electric field generated by applying the anode voltage and the auxiliary electrode voltage to the electron emission display device having a low resistance spacer according to the embodiment of the present invention as shown in FIGS. 5A and 5B. As shown in the drawing, in the electron emission display device including the auxiliary electrodes, the orbits of the electrons emitted from the electron emitting parts are concentrated on the anode electrode 220 by the auxiliary electrodes 180 so that the electrons are prevented from being charged to the spacers 320. Thus, emission of different color light due to the orbit distortion of the electrons and the distortion and change of images due to the different color light emission can be reduced.

Moreover, charges are charged in the spacers by increasing the conductivity of the spacers so that the orbit distortion of the electron beams can be prevented.

FIG. 7 is a schematic sectional view illustrating the structure of an electron emission display device according to another embodiment of the present invention, and FIG. 8 is a schematic view illustrating the low resistance spacer shown in FIG. 7. As shown in the drawing, the electron emission display device 700 using low resistance spacers according to this embodiment of the present invention includes an electron emission substrate 100, in which at least one electron emission device is disposed, and auxiliary electrodes 718, electrically connected to portions of the electron emission substrate other than regions where the electron emission devices are formed. The electron emission display device also includes an image forming substrate 200, in which image implementing parts corresponding to the electron emission devices are formed, and low resistance spacers 730 for spacing the auxiliary electrodes 718 of the electron emission substrate 710 apart from the image forming substrate 200 to support the auxiliary electrodes 718. The spacers are formed by coating conductive material on the surfaces thereof.

The low resistance spacers 730 are formed by coating the low resistance material 731 on spacer members for supporting the electron emission substrate 100 to be spaced apart from the corresponding image forming substrate 200.

The low resistance spacers 730 are made of material as described above, such as silicon glass, glass containing Na, solar-lime glass, alumina, or ceramic containing alumina.

On the surfaces of the spacers 730, the above-described conductive material 731, such as metal such as Ni, Cr, Au, Mo, W, Pt, Ti, Al, Cu, and Pd, alloys thereof. Ni, Cr, Au, Mo, W, Pt, Ti, Al, Cu, and Pd, metal such as Pd, Ag, Au, RuO₂, and Pd—Ag, metal oxide of Pd, Ag, Au, RuO₂, and Pd—Ag, transparent conductor such as In₂O₃—SnO₂, and semiconductor such as poly silicon, is selected and coated.

By doing so, the low resistance spacers 730 can have resistance ranging from 10⁴ cm to 10¹⁴ Ωcm. Moreover, on the sides of the low resistance spacers 730, low resistance materials 732 may be formed, and their resistance is equal to or less than the resistance of the adhesives 733a and 733b. On at least one of the sides of the low resistance spacers 730, a conductor layer having higher conductivity than that of the low resistance spacers 730, may be formed.

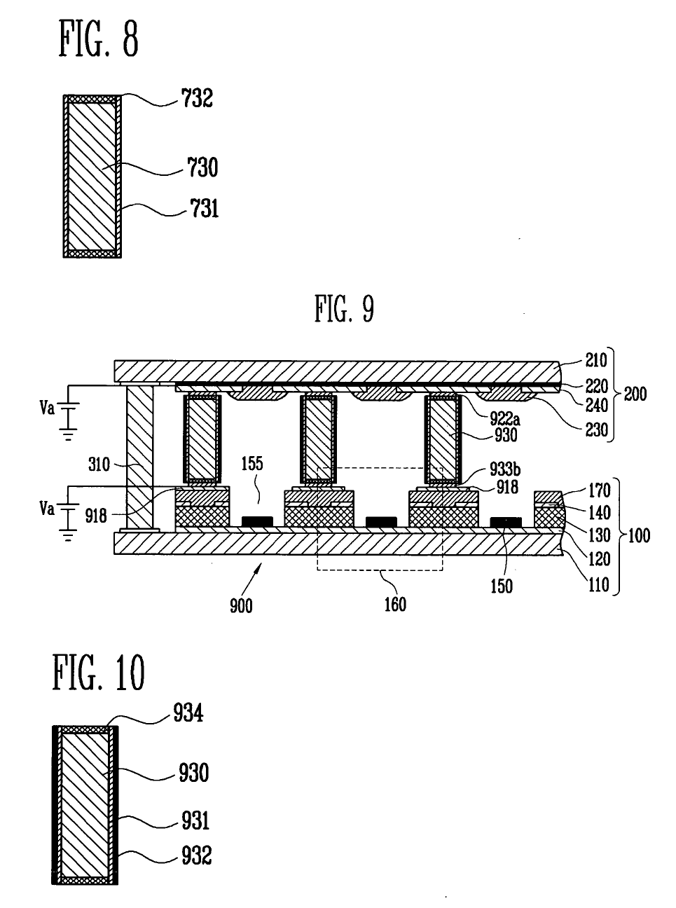

FIG. 9 is a schematic sectional view illustrating the structure of an electron emission display device according to another embodiment of the present invention, and FIG. 10 is a schematic view illustrating the structure of a low resistance spacer shown in FIG. 9. The electron emission display device using low resistance spacers according to this embodiment of the present invention includes an electron emission substrate 100, in which at least one electron emission device is disposed, and auxiliary electrodes 918, electrically connected to portions of the electron emission substrate other than the regions where the electron emission devices are formed. This embodiment also includes an image forming substrate 200, in which image implementing parts corresponding to the electron emission devices are formed, and low resistance spacers 930 for spacing the auxiliary electrodes 918 of the electron emission substrate 100 apart from the image forming substrate 200 to support the auxiliary electrodes 918. The spacers are formed by doubly coating conductive material having different resistance to the image forming substrate 200.

The low resistance spacers 930 for supporting the electron emission substrate to be spaced apart from the corresponding image forming substrate are coated with first and second low resistance materials 931 and 932. Here, the description of the spacers is as described above in relation to FIG. 8, and is therefore omitted.

The first low resistance material 931 and the second low resistance material 932 include materials with different resistances. For example, the conductive material coated firstly may be a metal such as Ni, Cr, Au, Mo, W, Pt, Ti, Al, Cu, and Pd, an alloy of Ni, Cr, Au, Mo, W, Pt, Ti, Al, Cu, and Pd, a metal such as Pd, Ag, Au, RuO₂, and Pd—Ag, a metal oxide of Pd, Ag, Au, RuO₂, and Pd—Ag, a transparent conductor such as In₂O₃—SnO₂, or a semiconductor such as poly silicon. The conductive material coated secondly has a resistance different from the conductive material coated firstly.

By doing so, the low resistance spacers 930 can have a resistance ranging from 10⁴ Ωcm to 10¹⁴ Ωcm. Moreover, on the sides of the low resistance spacers 930, low resistance materials 932 may be formed, and their resistance may be equal to or less than the resistance of the adhesives 933a and 933b. On at least one of the sides of the low resistance spacers 930, a conductor layer having higher conductivity than that of the low resistance spacers 930 may be formed.

Although a few embodiments of the present invention have been shown and described, it would be appreciated by those skilled in the art that changes might be made to these embodiments without departing from the principles and spirit of the invention, the scope of which is defined in the claims and their equivalents.

What is claimed is:

1. An electron emission display device comprising:
an electron emission substrate;
an electron emission device disposed on a region of the electron emission substrate;
an auxiliary electrode electrically connected to the electron emission substrate at a portion other than the region where the electron emission device is disposed;
an image forming substrate;
an image implementing part corresponding to the electron emission device disposed on the image forming substrate; and
a spacer for supporting the auxiliary electrode and the image forming substrate to be spaced apart from each other, the spacer comprising a conductive material.

2. The electron emission display device according to claim 1, wherein the spacer is fixed to at least one of the electron emission substrate or the image forming substrate by an adhesive.

3. The electron emission display device according to claim 2, wherein the adhesive comprises conductive material.

4. The electron emission display device according to claim 1, wherein the conductive material of the spacer comprises one metal selected from the group consisting of Ni, Cr, Au, Ag, Mo, W, Pt, Ti, Al, Cu, and Pd, one alloy selected from the group consisting of Ni, Cr, Au, Mo, W, Pt, Ti, Al, Cu, and Pd, one metal oxide selected from the group consisting of In₂O₃—SnO₂, and RuO₂, or poly silicon.

5. The electron emission display device according to claim 1, wherein the spacer has a resistance ranging from 10⁴ Ωcm to 10¹⁴ Ωcm.

6. The electron emission display device according to claim 2, wherein on at least one side of the spacer is located a low resistance material having a resistance equal to or less than a resistance of the adhesive.

7. The electron emission display device according to claim 1, wherein on least one side of the spacer is located a conductor layer having a higher conductivity than that of the spacer.

8. The electron emission display device according to claim 1, wherein the electron emission device comprises:
a cathode electrode;
an electron emitting part electrically connected to the cathode electrode;
a first insulating layer formed on the cathode electrode;
a gate electrode crossing the cathode electrode to emit electrons from the electron emitting part;
a second insulating layer formed on the gate electrode; and
the auxiliary electrode formed on the second insulating layer to collect the electrons emitted by the gate electrode.

9. The electron emission display device according to claim 8, wherein an external power source independently applies voltage ranging from −50V to +100V to the auxiliary electrode.

10. The electron emission display device according to claim 1, wherein the image implementing part comprises:
luminescent layers emitting light due to electrons emitted from the electron emission device;
a light shielding film disposed between the luminescent layers; and
an anode electrode electrically connected to the luminescent layers.

11. The electron emission display device according to claim 10, wherein a voltage is applied to the anode electrode and a negative voltage corresponding to voltage applied to the anode electrode is applied to the auxiliary electrode.

12. An electron emission display device comprising:
an electron emission substrate;
an electron emission device disposed on a region of the electron emission substrate;
an auxiliary electrode electrically connected to the electron emission substrate at a portion other than the region where the electron emission device is disposed;
an image forming substrate;
an image implementing part corresponding to the electron emission device disposed on the image forming substrate; and
a spacer for supporting the auxiliary electrode and the image forming substrate to be spaced apart from each other, the spacer coated with a conductive material.

13. The electron emission display device according to claim 12, wherein the conductive material coating the spacer comprises one metal selected from the group consisting of Ni, Cr, Au, Ag, Mo, W, Pt, Ti, Al, Cu, and Pd, one alloy selected from the group consisting of Ni, Cr, Au, Mo, W, Pt, Ti, Al, Cu, and Pd, one metal oxide selected from the group consisting of RuO₂, and In₂O₃—SnO₂, or poly silicon.

14. The electron emission display device according to claim 12, wherein the spacer has a resistance ranging from 10⁴ Ωcm to 10¹⁴ Ωcm.

15. An electron emission display device comprising:
an electron emission substrate;
an electron emission device disposed on a region of the electron emission substrate;
an auxiliary electrode electrically connected to the electron emission substrate at a portion other than the region where the electron emission device is disposed;
an image forming substrate;
an image implementing part corresponding to the electron emission device disposed on the image forming substrate; and
a spacer for supporting the auxiliary electrode and the image forming substrate to be spaced apart from each other, the spacer having a first coating of a first conductive material and a second coating of a second conductive material, the first conductive material having a different resistance than the second conductive material.

16. The electron emission display device according to claim 15, wherein the first conductive material comprises one metal selected from the group consisting of Ni, Cr, Au, Ag, Mo, W, Pt, Ti, Al, Cu, and Pd, one alloy selected from the group consisting of Ni, Cr, Au, Mo, W, Pt, Ti, Al, Cu, and Pd, one metal oxide selected from the group consisting of RuO₂ and In₂O₃—SnO₂, or poly silicon.

17. The electron emission display device according to claim 16, wherein the second conductive material comprises one metal selected from the group consisting of Ni, Cr, Au, Ag, Mo, W, Pt, Ti, Al, Cu, and Pd, one alloy selected from the group consisting of Ni, Cr, Au, Mo, W, Pt, Ti, Al, Cu, and Pd, one metal oxide selected from the group consisting of RuO₂ and In₂O₃—SnO₂, or poly silicon.

18. The electron emission display device according to claim 15, wherein the spacer has a resistance ranging from 10⁴ Ωcm to 10¹⁴ Ωcm.

19. The electron emission display device according to claim 15, wherein the spacer is formed of an insulating material selected from the group consisting of silicon glass, glass containing Na, solar-lime glass, alumina, and ceramic containing alumina.

20. The electron emission display device according to claim 15, wherein a thermal expansion coefficient of the spacer is approximately equal to a thermal expansion coefficient of the electron emission substrate and a thermal expansion coefficient of the image forming substrate.
